(19) United States
(12) Patent Application Publication
(10) Pub. No.: US 2015/0115926 A1
(43) Pub. Date: Apr. 30, 2015

(54) POWER SUPPLY DEVICE

(71) Applicant: SAMSUNG ELECTRO-MECHANICS CO., LTD., SUWON (KR)

(72) Inventors: Min Sup SONG, SUWON (KR); YOUNG DONG SON, SUWON (KR); CHANGSUNG SEAN KIM, SUWON (KR); GEUN HONG LEE, SUWON (KR)

(73) Assignee: SAMSUNG ELECTRO-MECHANICS CO., LTD., SUWON (KR)

(21) Appl. No.: 14/163,888

(22) Filed: Jan. 24, 2014

(30) Foreign Application Priority Data
Oct. 31, 2013 (KR) 10-2013-0131601

(51) Int. Cl. H02M 3/158; H02M 1/14

(52) U.S. Cl. CPC H02M 3/158; H02M 1/14
USPC 323/290

(57) ABSTRACT

There is provided a power supply device including: a SEPIC/Zeta converter having an energy storage unit; and a power transmitting unit transmitting the energy stored in the SEPIC/Zeta converter to a load stage.

### CROSS-REFERENCE TO RELATED APPLICATION

This application claims the benefit of Korean Patent Application No. 10-2013-0131601 filed on Oct. 31, 2013, with the Korean Intellectual Property Office, the disclosure of which is incorporated herein by reference.

### BACKGROUND

The present disclosure relates to a power supply device.

A bidirectional direct current (DC)-DC converter is a type of power converter that controls the flow of power between two power sources in two directions. Here, in the case of a unidirectional converter, two DC-DC converters are required, since a single unidirectional DC-DC converter must be used in each direction of conversion, in order to control the flow of power in two directions. When a bidirectional converter is employed, however, a system can be simplified so that the overall volume of the circuit system can be reduced. Such bidirectional converters include insulation-type converters employing a transformer between input and output, and non-insulation-type converters without employing a transformer. Such insulation-type converters are used when the input and output currents should be electrically insulated or when a high voltage conversion ratio is necessary. However, due to the size and cost of the transformer, such insulation-type converters are frequently used for large and medium output voltage applications. Non-insulation-type converters are not able to achieve electrical insulation and a high step-up/step-down ratio, but are advantageous in that such converters are able to be implemented at low cost and have a simple circuit configuration, such that they are frequently used for small and medium power applications handling power levels below 60 V.

At present, applications of bidirectional DC-DC converters are gradually increasing, and such converters are being adopted for use in devices such as battery chargers, uninterruptible DC power supplies (UPS), electric motors for electric automobiles and the like.

### RELATED ART DOCUMENT

(Patent Document 1) Korean Patent Laid-open Publication No. 2012-0048154

### SUMMARY

An aspect of the present disclosure may provide a power supply device capable of stepping up and stepping down an input voltage with high efficiency.

An aspect of the present disclosure may also provide a power supply device capable of reducing switching loss and conduction loss in a switching element.

An aspect of the present disclosure may also provide a power supply device capable of improving efficiency of a circuit system by reducing inductor ripple currents and capacitor ripple voltages.

According to an aspect of the present disclosure, a power supply device may include: a Single-Ended Primary-Inductor Converter (SEPIC) or a Zeta converter having an energy storage unit; and a power transmitting unit transmitting the energy stored in an energy storage unit of the SEPIC/Zeta converter to a load stage.

The SEPIC/Zeta converter may include: a first inductor connected between a first node and a second node; a first switch connected between the second node and a ground so as to be switched according to a first switching signal; a separation capacitor connected between the second node and a third node; a second inductor connected between the third node and the ground; and a second switch connected between the third node and a fourth node.

The power supply device may further include: an input capacitor connected between the first node and the ground; and an output capacitor connected between the fourth node and the ground.

The power transmitting unit may be connected between the second node and the fourth node.

The power transmitting unit may include a third switch, a fourth switch, and an auxiliary inductor connected in series.

According to another aspect of the present disclosure, a power supply device may include: a first inductor connected between a first node and a second node; a first switch connected between the second node and a ground so as to be switched according to a first switching signal; a separation capacitor connected between the second node and a third node; a second inductor connected between the third node and the ground; a second switch connected between the third node and a fourth node; and a power transmitting unit disposed between the second node and the fourth node so as to provide a power transmission path.

The power supply device may further include: an input capacitor connected between the first node and the ground; and an output capacitor connected between the fourth node and the ground potential.

The power transmitting unit may be connected between the second node and the fourth node.

The power transmitting unit may include a third switch, a fourth switch, and an auxiliary inductor connected in series.

A power input unit may be connected between the first node and the ground; and a load may be connected between the fourth node and the ground.

A load may be connected between the first node and the ground; and a power input unit may be connected between the fourth node and the ground.

### BRIEF DESCRIPTION OF DRAWINGS

The above and other aspects, features and other advantages of the present disclosure will be more clearly understood from the following detailed description taken in conjunction with the accompanying drawings, in which:

FIG. 1 is a circuit diagram of a power supply device according to an exemplary embodiment of the present disclosure;

FIG. 2 is a circuit diagram of a power supply device according to another exemplary embodiment of the present disclosure;

FIG. 3 is a circuit diagram of a simulation test circuit for the power supply device shown in FIG. 1;

FIG. 4 shows waveforms of parts of the circuit shown in FIG. 3;

FIG. 5 is a circuit diagram of a simulation test circuit for the power supply device shown in FIG. 1 and

FIG. 6 shows waveforms of parts of the circuit shown in FIG. 5.

### DETAILED DESCRIPTION

Hereinafter, embodiments of the present invention will be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art. Throughout the drawings, the same or like reference numerals will be used to designate the same or like elements.

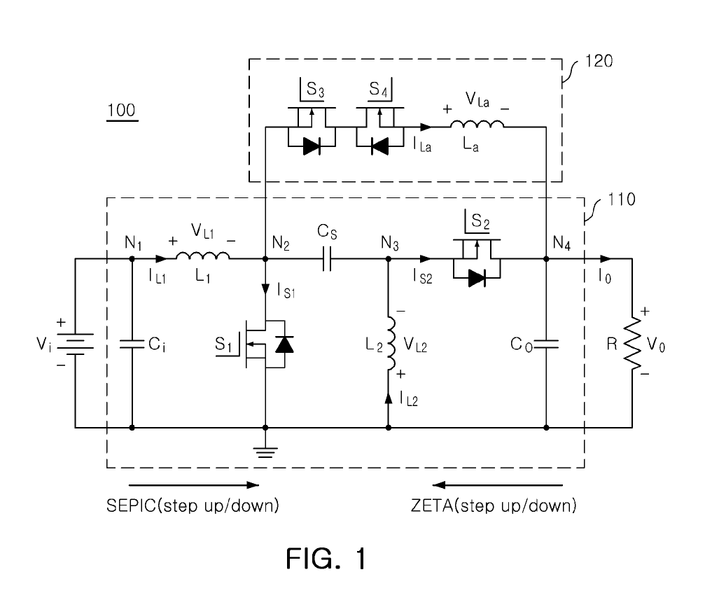

FIG. 1 is a circuit diagram of a power supply device according to an exemplary embodiment of the present disclosure.

Referring to FIG. 1, the power supply device 100 may include an input voltage source Vi, a power converting unit 110, and a direct power transmitting unit 120.

The power converting unit 110 may employ a Single-Ended Primary-Inductor Converter SEPIC/Zeta (known as the inverted SEPIC) topology.

The SEPIC converter and the Zeta converter may step up as well as step down an input voltage.

The SEPIC/Zeta converter may operate as a SEPIC converter in one direction and may operate a Zeta converter in the other direction.

That is, by replacing a diode element with an active switching element in existing SEPIC converters and Zeta converters and by configuring a circuit as shown in FIG. 1, it may be possible to provide a SEPIC/Zeta converter that operates as a SEPIC converter in the direction as indicated by the arrow at the left side of FIG. 1 and operates as a Zeta converter in the direction as indicated by the arrow on the right of FIG. 1. That is, the power converting unit 110 may operate as a direct current (DC) to DC converter, operable to step up and step down an input voltage bi-directionally.

The power supply device 100 according to an exemplary embodiment of the present disclosure may operate as a bidirectional SEPIC/Zeta converter. The power supply device 100 according to an exemplary embodiment of the present disclosure may operate as a SEPIC converter in one direction and may operate as a Zeta converter in the other direction.

For convenience of explanation, an example in which the power supply device according to an exemplary embodiment of the present disclosure operates as a SEPIC converter will be described.

The input voltage source Vi may be connected between a first node N1 of the power converting unit 110 and the ground. The input voltage source Vi may supply an input voltage at a certain level to the power converting unit 110 and may be a wall concent or a battery.

The power converting unit 110 may include an input capacitor Ci, a first inductor L1, a first switching element S1, a separation capacitor Cs, a second inductor L2, a second switching element S2, and an output capacitor Co.

The input capacitor Ci may be connected between the first node N1 and the ground. The input capacitor Ci may store a voltage supplied from the input voltage source Vi according to the switching of a first switching element S1 and may release the stored energy.

The first inductor L1 may be connected between the first node N1 and the second node N2. That is, one terminal of the first inductor L1 may be connected to the first node N1, and the other terminal thereof may be connected to one terminal of the separation capacitor Cs through the second node N2. The first inductor L1 may store the energy supplied from the input voltage source Vi and/or the input capacitor Ci according to the switching of the first switching element S1 and may release the stored energy.

The first switching element S1 may be switched according to a first switching signal with a predetermined on-duty cycle supplied from an external duty control unit (not shown) so as to control the current flowing in the power converting unit 110. To this end, the first switching element S1 may include a gate terminal to which the first switching signal is input, a drain terminal connected to the second node N2, and a source terminal connected to the ground. The first switching element S1 may include a field effect transistor (FET), an insulated gate bipolar transistor (IGBT), and an integrated gate commutated thyristor (IGCT).

The first switching element S1 may further include an internal diode that is forward biased in the direction from the source terminal to the drain terminal.

The separation capacitor Cs may be connected between the second node N2 and the third node N3. That is, one terminal of the separation capacitor Cs may be connected to the second node N2 and the other terminal thereof may be connected to the third node N3. The separation capacitor Cs may store energy according to the switching of the first switching element S1 and may release the stored energy to a load.

The second inductor L2 may be connected between the third node N3 and the ground. That is, one terminal of the second inductor L2 may be connected to the third node N3 and the other terminal thereof may be connected to the ground. The second inductor L2 may store energy according to the switching of the first switching element S1 and may release the stored energy to the load or to the separation capacitor Cs to charge it with the energy.

The second switching element S2 may be switched according to a second switching signal with a predetermined on-duty cycle supplied from an external duty control unit (not shown) so as to control the current flowing in the power converting unit 110. To this end, the second switching element S2 may include a gate terminal to which the second switching signal is input, a drain terminal connected to the third node N3, and a source terminal connected to a fourth node N4. The second switching element S2 may include a field effect transistor (FET), an insulated gate bipolar transistor (IGBT), and an integrated gate commutated thyristor (IGCT).

The second switching element S2 may further include an internal diode that is forward biased in the direction from the source terminal to the drain terminal.

The internal diode disposed in the second switching element S2 may be connected between the third node N3 and the fourth node N4. That is, the anode terminal of the internal diode may be connected to the third node N3 and the cathode terminal thereof may be connected to the fourth node N4. The internal diode may become conductive depending on the potential difference between the third node N3 and the fourth node N4 so as to transmit the energy stored in the first and second inductors L1 and L2 to the fourth node N4. In addition, the internal diode may block the reverse current flowing from the fourth node N4 toward the third node N3.

The output capacitor Co may be connected between the fourth node N4 and the ground. That is, one terminal of the output capacitor Co may be connected to the fourth node N4 and the other terminal thereof may be connected to the ground. The capacitor may smooth the voltage output to the load through the fourth node N4 flat and store it when the first switching element S1 is switched on, and may output the stored voltage to the load through the fourth node N4 when the first switching element S1 is switched off. The load may include a light emitting diode (LED), a light emitting diode array (LED array), a back light unit, various types of information devices, or a display device.

The power converting unit 110 may charge the first inductor L1 while charging the second inductor L2 by releasing the energy stored in the separation capacitor Cs when the first switching element S1 is switched on according to the first switching signal, and may release the energy stored in the first and second inductors L1 and L2 to the fourth node N4 while charging the output capacitor Co when the first switching element S1 is switched off according to the first switching signal.

The power transmitting unit 120 may create an additional power transmission path.

The power transmitting unit 120 may include a third switch S3, a fourth switch S4, and an auxiliary inductor element La.

The third switch S3, the fourth switch S4 and the auxiliary inductor element La may be connected in series.

One terminal of the third switch S3 may be connected to the second node N2. One terminal of the auxiliary inductor element La may be connected to the fourth node N4.

The third switching element S3 may further include an internal diode that is forward biased in the direction from the source terminal to the drain terminal. The fourth switching element S4 may further include an internal diode that is forward biased in the direction from the source terminal to the drain terminal.

The drain terminal of the third switching element S3 and the drain terminal of the fourth switching element S4 may be connected to each other.

The third and fourth switching elements S3 and S4 may supply the current supplied through the second node N2 to the auxiliary inductor element La.

The auxiliary inductor element La may store the energy supplied according to the switching of the third switching element S3 and the fourth switching element S4 so as to reduce the level of current flowing the first switching element S1 and the switching loss, such that the first switching element S1 is soft switched.

The power transmitting unit 120 may soft switch the third switching element and the fourth switching element after the first switching element S1 is switched off and thereby create a power path from the first inductor L1 to the fourth node N4 through an auxiliary inductor element La by itself, so as to output by itself to the fourth node N4 the substantial amount of power that has no switching loss and is directly transmitted with high efficiency.

Further, the power transmitting unit 120 may linearly increase the current flowing through the first switching element S1 slowly by using the current characteristic of the auxiliary inductor element La when the first switching element S1 is switched on and thereby soft switching the first switching element S1, such that turn-on loss in the first switching element S1 and turn-off loss in the third and fourth switching elements S3 and S4 may be eliminated.

Furthermore, the power transmitting unit 120 may linearly increase the current flowing through the third and fourth switching element S3 and S4 so as to slowly linearly decrease the current flowing through the second switching element S2 by using the current characteristic of the auxiliary inductor element La when the path via the second switch is blocked, such that the turn-off loss in the second switching element S2 and the turn-on loss in the third and fourth switching elements are eliminated.

That is, the power supply device according to an exemplary embodiment of the present disclosure may create by itself the current path from the first inductor L1 to the fourth node N4 through the power transmitting unit 120 so as to output by itself to a load the substantial amount of power via the auxiliary inductor element La with no switching loss, while outputting the amount of power necessary for converting the rest of voltage and current via the power converting unit 110.

As a result, the power supply device 100 according to an exemplary embodiment of the present disclosure may reduce power loss in each of the switching elements through the power transmitting unit 120, thereby improving DC-DC conversion efficiency.

Thus far, an example in which the power supply device according to an exemplary embodiment of the present disclosure operates as a SEPIC converter has been described. It will be apparent to those skilled in the art that the power supply device may operate as a Zeta converter by switching positions of the power input unit and the load, and thus a detailed description thereof will not be made.

That is, if the power supply device according to an exemplary embodiment of the present disclosure operates as a Zeta converter, a load is connected between the first node and the ground, and a power input unit may be connected between the fourth node and the ground.

Further, if the power supply device according to an exemplary embodiment of the present disclosure operates as a Zeta converter, the second switching element S2 may perform the function of the first switching element S1 instead.

The additional transmission path created by the power transmitting unit 120 may perform direct power transmission between input and output.

Here, when the power supply device operates as a SEPIC converter, the conversion ratio of output to input may be expressed as Vo/Vi=(1−D2)/(1−D1). In addition, when the power supply device operates as a Zeta converter, the conversion ratio of output to input may be expressed as Vo/Vi=(1−D1)/(1−D2).

Where D1 denotes the conduction ratio of the first switch S1, and D2 denotes the conduction ratio of the second switch S2.

As such, the power supply device according to an exemplary embodiment of the present disclosure may be operable to step up and step down an input voltage, unlike existing bidirectional converters. For instance, an input voltage is between 10 V and 20 V and an output voltage is between 10 V and 20 V, the power supply device according to an exemplary embodiment of the present disclosure may be used even if the range of the input and output voltages overlap.

Further, in the power supply device according to an exemplary embodiment of the present disclosure, when power is transmitted via the additional power transmission path, the voltages applied to the first inductor L1 and the second inductor L2 are reduced to Vi-Vo, so that ripple currents are reduced. If the ripple currents are reduced, the rms current in the circuit is reduced, so that inductor DC resistance loss and capacitor serial resistance loss may be reduced, thereby increasing efficiency. That is, efficiency may be increased as the time in which power is transmitted via the additional power transmission path is increased.

Further, the auxiliary inductor La on the additional power transmission path may derive soft current commutation between switching elements, thereby allowing zero current switching (ZCS).

In addition, the power supply device according to an exemplary embodiment of the present disclosure replaces existing diodes with active switches to allow zero voltage switching (ZVS), thereby reducing switching conduction loss.

In addition, if a switch is switched on or off while an internal diode included in a switching element is conductive, zero voltage switching may be made.

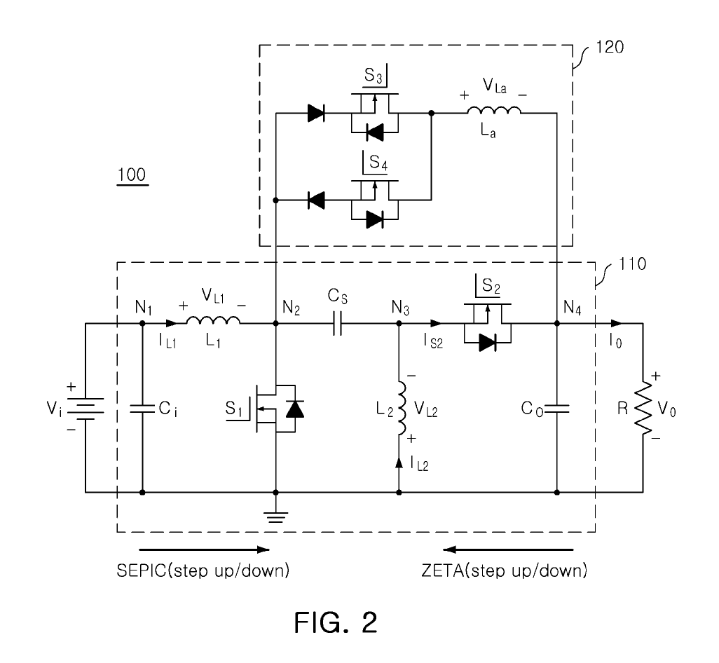

FIG. 2 is a circuit diagram of a power supply device according to another exemplary embodiment of the present disclosure.

Since the configuration of the power converting unit is the same as that of the power supply device according to the exemplary embodiment described above, a detailed description thereof will be omitted.

The power transmitting unit 120 may have two power transmission paths. That is, a diode element, a third switching element S3, and an auxiliary inductor element La may create a power transmission path for a SEPIC converter mode. The diode element, the third switching element S3, and the auxiliary inductor element La may be connected in series between a second node N2 and a fourth node N4.

In addition, a diode element, a fourth switching element S4, and the auxiliary inductor element La may create a power transmission path for a Zeta converter mode. The diode element, the fourth switching element S4, and the auxiliary inductor element La may be connected in series between the second node N2 and the fourth node N4.

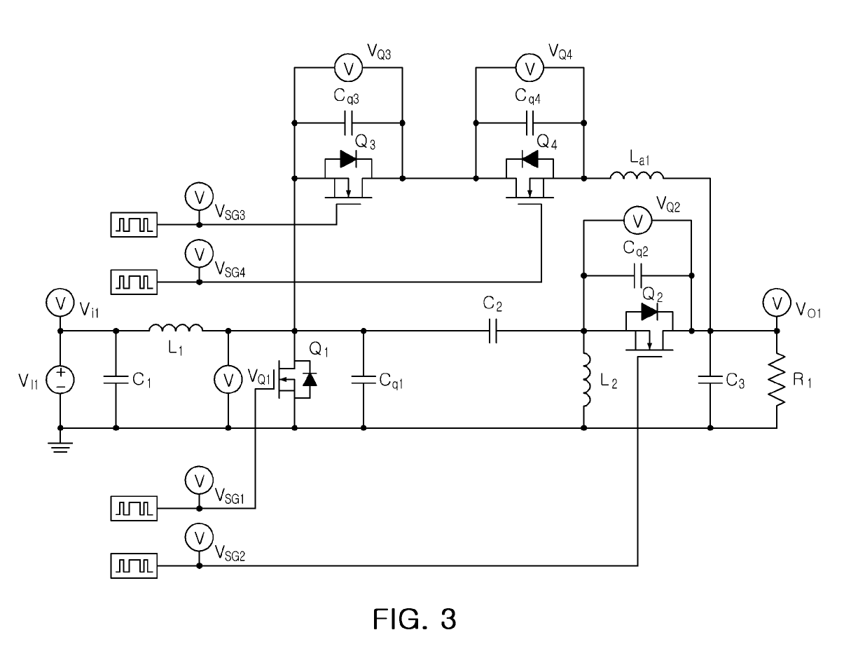

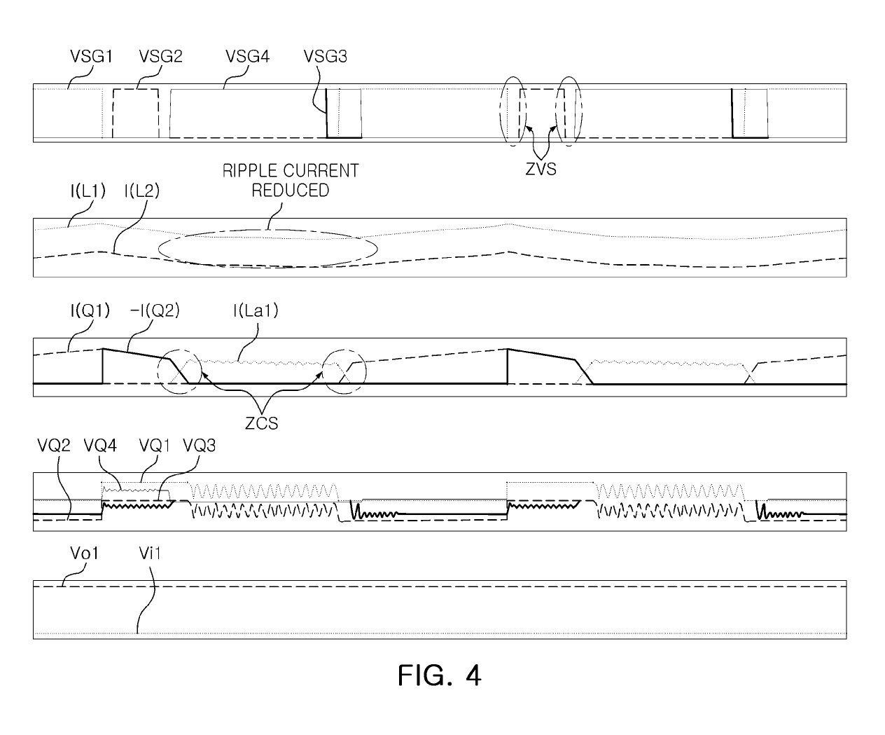

FIG. 3 is a circuit diagram of a simulation test circuit for the power supply device shown in FIG. 1. FIG. 3 shows a SEPIC converter mode. FIG. 4 shows waveforms of parts of the circuit shown in FIG. 3.

Referring to FIG. 4, it can be seen that inductor ripple currents are reduced by virtue of the additional power transmission path.

Further, ZCS and ZVS of the switching elements may be seen by soft current commutation of the auxiliary inductor La and appropriate switch control.

That is, it can be seen that the switching element Q1 may be switched on with zero current. Further, it can be seen that the switching element Q2 may be switched on or off with zero-voltage.

Further, it can be seen that the internal diode DQ2 in the switching element Q2 may be switched off with zero-current. Further, it can be seen that the internal diode DQ3 in the switching element Q3 may be switched on or off with zero-current.

Further, it can be seen that the switching elements Q3 and Q4 may be switched on or off with zero-current.

Further, it can be seen that the switching elements Q2 and Q3 are also switched with zero-voltage.

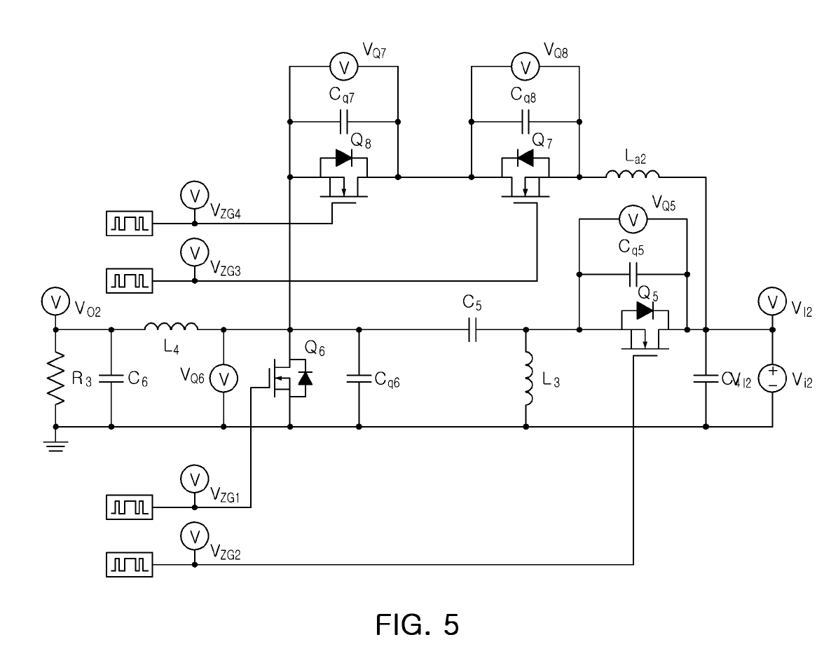

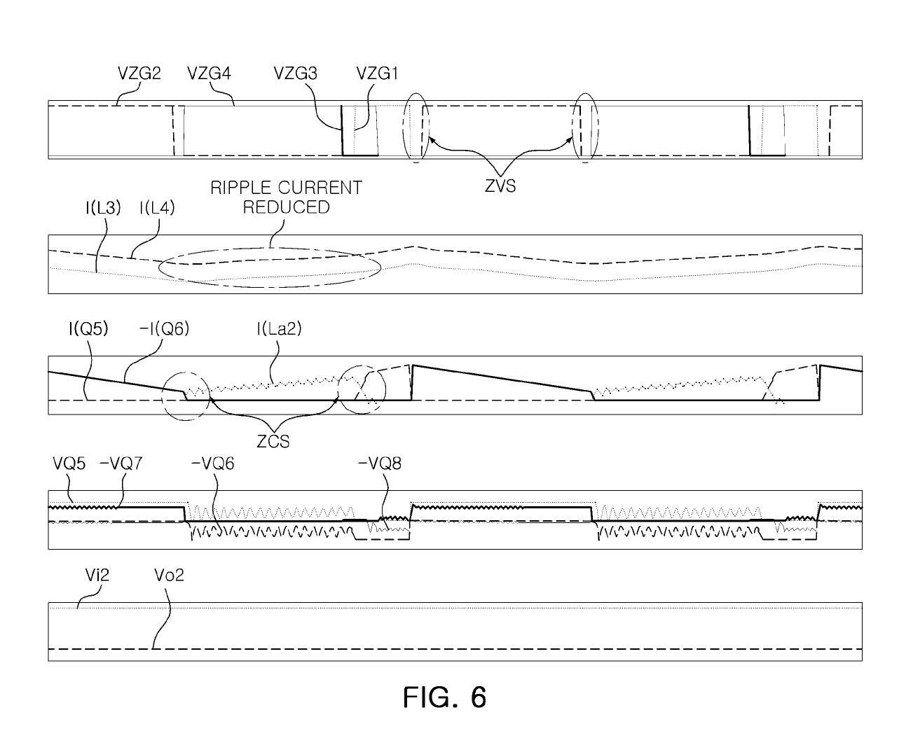

FIG. 5 is a circuit diagram of a simulation test circuit for the power supply device shown in FIG. 1. FIG. 5 shows a Zeta converter mode. FIG. 6 shows waveforms of parts of the circuit shown in FIG. 5.

Referring to FIG. 6, it can be seen that inductor ripple currents are reduced by virtue of the additional power transmission path.

Further, ZCS and ZVS of the switching elements can be seen by soft current commutation of the auxiliary inductor La and appropriate switch control.

That is, it can be seen that the switching element Q5 may be zero current switched when it is switched on. Further, it can be seen that the switching element Q6 may be zero-voltage-switched when it is switched on or off.

Further, it can be seen that the internal diode DQ6 in the switching element Q6 may be zero-current-switched when it is switched off. Further, it can be seen that the internal diode DQ7 in the switching element Q7 may be zero-current-switched when it is switched on or off.

Further, it can be seen that the switching elements Q7 and Q8 may be zero-current-switched when it is switched on or off.

Further, it can be seen that the switching elements Q6 and Q7 are also zero-voltage switched.

As set forth above, according to exemplary embodiments of the present disclosure, a power supply device capable of stepping up and stepping down an input voltage with high efficiency may be provided.

Further, according to exemplary embodiments of the present disclosure, a power supply device capable of reducing switching loss and conduction loss in a switching element may be provided.

Moreover, according to exemplary embodiments of the present disclosure, a power supply device capable of improving efficiency of a circuit system by reducing inductor ripple currents and capacitor ripple voltages may be provided.

While exemplary embodiments have been shown and described above, it will be apparent to those skilled in the art that modifications and variations could be made without departing from the spirit and scope of the present disclosure as defined by the appended claims.

What is claimed is:

1. A power supply device, comprising:
a SEPIC/Zeta converter having an energy storage unit; and
a power transmitting unit transmitting the energy stored in an energy storage unit of the SEPIC/Zeta converter to a load stage.

2. The power supply device of claim 1, wherein the SEPIC/Zeta converter includes:
a first inductor connected between a first node and a second node;
a first switch connected between the second node and a ground so as to be switched according to a first switching signal;
a separation capacitor connected between the second node and a third node; and
a second inductor connected between the third node and the ground.

3. The power supply device of claim 2, further comprising: an input capacitor connected between the first node and the ground; and
an output capacitor connected between the fourth node and the ground.

4. The power supply device of claim 3, wherein the power transmitting unit is connected between the second node and the fourth node.

5. The power supply device of claim 4, wherein the power transmitting unit includes a third switch, a fourth switch, and an auxiliary inductor connected in series.

6. A power supply device, comprising:
a first inductor connected between a first node and a second node;
a first switch connected between the second node and a ground so as to be switched according to a first switching signal;
a separation capacitor connected between the second node and a third node;
a second inductor connected between the third node and the ground;
a second switch connected between the third node and a fourth node; and
a power transmitting unit disposed between the second node and the fourth node so as to provide a power transmission path.

7. The power supply device of claim 6, further comprising:
an input capacitor connected between the first node and the ground; and
an output capacitor connected between the fourth node and the ground.

8. The power supply device of claim 7, wherein the power transmitting unit is connected between the second node and the fourth node.

9. The power supply device of claim 8, wherein the power transmitting unit includes a third switch, a fourth switch, and an auxiliary inductor connected in series.

10. The power supply device of claim 6, wherein a power input unit is connected between the first node and the ground, and a load is connected between the fourth node and the ground.

11. The power supply device of claim 6, wherein a load is connected between the first node and the ground, and a power input unit is connected between the fourth node and the ground.
